(19) United States
(12) Patent Application Publication
(10) Pub. No.: US 2020/0408143 A1
(43) Pub. Date: Dec. 31, 2020

(54) Turbocharger Turbine Rotor and Turbocharger

(71) Applicant: MAN Energy Solutions SE, Augsburg (DE)

(72) Inventors: Alfons BORNHORN, Aystetten (DE); Stefan ROST, Augsburg (DE); Christoph LEITENMEIER, Augsburg (DE); Felix FIGASCHEWSKY, Berlin (DE); Bernd BEIROW, Cottbus (DE); Arnold KÜHHORN, Berlin (DE)

(73) Assignee: MAN Energy Solutions SE

(21) Appl. No.: 16/911,365

(22) Filed: Jun. 24, 2020

(30) Foreign Application Priority Data
Jun. 27, 2019 (DE) 10 2019 117 298.5

(51) Int. Cl. F02B 39/04

(52) U.S. Cl. CPC F02B 39/04

(57) ABSTRACT

A turbocharger turbine rotor includes a rotor basic body, and moving blades configured without an outer shroud. The moving blades, forming a defined curvature region, merge into the rotor basic body with a defined, constant or variable curvature radius r_{f}. On a first group of first moving blades, the following relationship applies to the curvature radius of the curvature region of the first moving blades: 2.5%≤r_{f1}*100/l≤10%, wherein r_{f1} is the constant or variable curvature radius of the curvature region of the first moving blades and l the length of the first moving blades on a flow trailing edge. On a second group of second moving blades, the curvature radius r_{f2} of the curvature region of the second moving blades deviates from the curvature radius rf1 of the curvature region of the first moving blades on the damping side in a defined manner.

### BACKGROUND OF THE INVENTION

### 1. Field of the Invention

The invention relates to a turbocharger turbine rotor and to a turbocharger having such a turbine rotor.

### 2. Description of the Related Art

Turbochargers comprise a turbine and a compressor. The turbine of a turbocharger serves for expanding a first medium, in particular exhaust gas of an internal combustion engine. The compressor serves for compressing a second medium, in particular charge air to be fed to the internal combustion engine, wherein the compressor utilizes energy extracted in the turbine during the expansion of the first medium.

The turbine of the turbocharger comprises a turbine housing and a turbine rotor. The compressor of a turbocharger comprises a compressor rotor and a compressor housing.

The turbine rotor of the turbine and the compressor rotor of the compressor are coupled via a shaft which is mounted in a bearing housing, wherein the bearing housing is connected on the one hand to the turbine housing and on the other hand to the compressor housing.

From DE 20 2012 009 739 U1 it is already known to embody a turbine rotor of a turbocharger as an integrally cast component, i.e., in the case of which moving blades of the turbine rotor are integrally formed on the rotor basic body of the turbine rotor. Such turbine rotors with moving blades formed integrally on the basic body are also referred to as blisk (blade integrated disc).

To date, such integrally bladed rotors have been known primarily from the aircraft engine industry. In aircraft engines, critical operating points of an aircraft engine, i.e., operating points in the natural frequency range, are passed through as quickly as possible and the engine specifically operated below or above such a critical operating point. For this reason, the use of integrally bladed turbine rotors is uncritical in aircraft engines.

In turbochargers, by contrast, an integrally bladed rotor has to be designed for all load cases, in particular a continuous operation in a critical load range also has to be considered since the turbocharger is an assembly of a combustion engine and operated as a function of the operating point of the internal combustion engine. It is therefore necessary to embody integrally bladed turbine rotors of the turbochargers so as to be resonance-proof.

In the turbocharger turbine rotor of DE 10 2012 009 739 U1 this is ensured in that the integrally bladed turbine rotor comprises an outer shroud, via which the moving blades are connected to one another at a radially outer end. Such an outer shroud however is situated in the flow region of the exhaust gas to be expanded and has a negative effect on the flow behavior. In particular, the efficiency of a turbocharger deteriorates because of this. There is a need for a turbine rotor for a turbocharger which is embodied resonance-proof even without interfering outer shroud, i.e., which can also be continuously operated in the critical operating point of the natural frequency range.

### SUMMARY OF THE INVENTION

Starting out from this, it is an object of the present invention to create a new type of turbocharger turbine rotor and a turbocharger having such a turbocharger turbine rotor. This object may be achieved through a turbocharger turbine rotor comprising a rotor basic body and moving blades integrally formed on the rotor basic body, wherein the moving blades are formed without an outer shroud. Forming a defined curvature region with a defined constant or variable curvature radius r_{f}, the moving blades merge into the rotor basic body. The relationship: 2.5%≤r_{f1}*100/l≤10% applies to the curvature radius of the curvature region of the first moving blade on a first group of first moving blades, wherein r_{f1} is the constant or variable curvature radius of the curvature region of the first moving blades and l is the length of the first moving blades at a flow trailing edge (6). On a second group of second moving blades, the curvature radius r_{f2} of the curvature region of the second moving blades deviates from the curvature radius r_{f1} of the curvature region of the first moving blades on the damping side in a defined manner. The first group of first moving blades comprises multiple first moving blades. The second group of second moving blades comprises at least one second moving blade.

In the integrally bladed turbocharger turbine rotor according to an aspect of the invention, an outer shroud is omitted. The moving blades of the integrally bladed turbocharger turbine rotor according to an aspect of the invention merge into the rotor basic body forming a defined curvature region. On the, or each, second moving blade, the constant, or variable, curvature radius of the respective curvature region deviates from the constant, or variable, curvature radius of the curvature region of the first moving blades on the damping side in a defined manner. Through the defined deviation on the damping side of the curvature radius on the, or each, second moving blade to the curvature radius of the first moving blades, a specific frequency detuning between the individual blades of the turbocharger turbine rotor is adjusted. By way of this, so-called vibration-side node diameters as well as vibration amplitudes can be specifically manipulated for adjusting an optimal damping of the turbocharger turbine rotor. From a structure-dynamic point of view, optimal phase positions can be adjusted on adjacent moving blades.

In particular when the curvature radius r_{f1} on the first moving blades is constant, 120%≤r_{f2}/r_{f1}≤300% preferentially applies to the curvature radius r_{f2} of curvature region of the respective second moving blade. In particular when the curvature radius r_{f1} on the first moving blades is constant, the curvature radius r_{f2} on the receptive second moving blade is also constant. This is preferred for ensuring optimum damping characteristics of an integrally bladed turbocharger turbine rotor without an outer shroud.

In particular when the curvature radius r_{f1} on the first moving blades is variable, 130%≤r_{f2}/r_{f1}≤400% preferentially applies to the curvature radius r_{f2} of the curvature region of the respective second moving blade. In particular when the curvature radius r_{f1} on the first moving blades is variable, the curvature radius r_{f2} on the respective second moving blade is also variable. This is preferred for ensuring optimum damping characteristics of an integrally bladed turbocharger turbine rotor without outer shroud.

According to a further development of the invention, the number of the second moving blades in the total number of the moving blades of first moving blades and second moving blades amounts to between 15% and 60%. By way of this, the damping characteristics of the integrally bladed turbocharger turbine rotor without outer shroud can be optimally adjusted.

The turbocharger according to an aspect of the invention is defined hereinafter. Preferred further developments of the invention are obtained from the following description.

### BRIEF DESCRIPTION OF THE DRAWINGS

Exemplary embodiments of the invention are explained in more detail by way of the drawings without being restricted to this. In the drawings:

FIG. 1 is a perspective view of a turbocharger turbine rotor of an axial turbine according to the invention;

FIG. 2 shows the detail II of FIG. 1;

FIG. 3 is a perspective view of a turbocharger turbine rotor of a radial turbine according to the invention;

FIG. 4 shows the detail IV of FIG. 3; and

FIG. 5 is a detail of FIG. 2 or 4.

### DETAILED DESCRIPTION OF THE PRESENTLY PREFERRED EMBODIMENTS

The invention relates to turbocharger turbine rotor and to a turbocharger having such a turbocharger turbine rotor.

A turbocharger comprises a turbine and a compressor. The turbine serves for expanding a first medium, in particular for expanding exhaust gas of an internal combustion engine, wherein during the expansion of the first medium energy is extracted. The compressor of the turbocharger serves for compressing a second medium, in particular for compressing charge air, utilizing energy extracted in the turbine.

The turbine of the turbocharger comprises a turbine housing and a turbine rotor that is rotatably mounted in the turbine housing. The compressor of the turbocharger comprises a compressor housing and a compressor rotor that is rotatably mounted in the compressor housing. Turbine rotor and compressor rotor of the turbocharger are coupled via a shaft, which is rotatably mounted in a bearing housing, wherein the bearing housing is connected both to the turbine housing and also to the compressor housing.

The invention relates to details of the turbine rotor of a turbocharger.

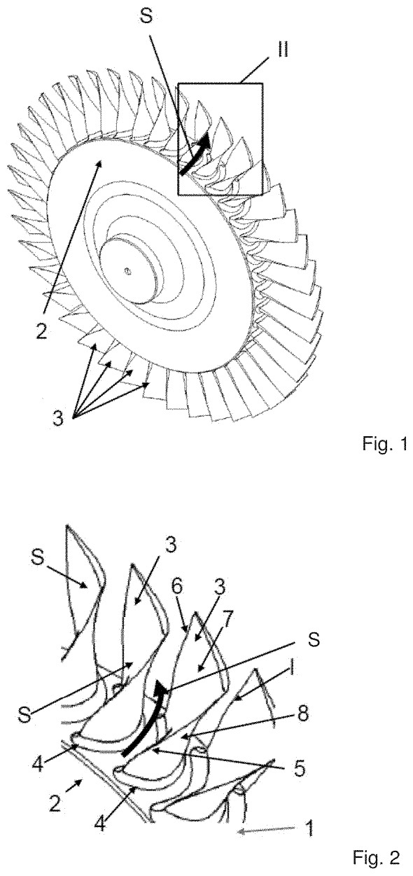

FIG. 1 shows a perspective view of a turbocharger turbine rotor 1, which comprises a rotor basic body 2 and moving blades 3 that are integrally formed on the rotor basic body 2. FIG. 2 shows the detail II of FIG. 1. Because of the axial flow direction in the turbocharger turbine rotor, this design is referred to as turbocharger axial turbine rotor. The flow direction of the turbocharger axial turbine rotor is visualized in FIG. 1, 2 by an arrow S.

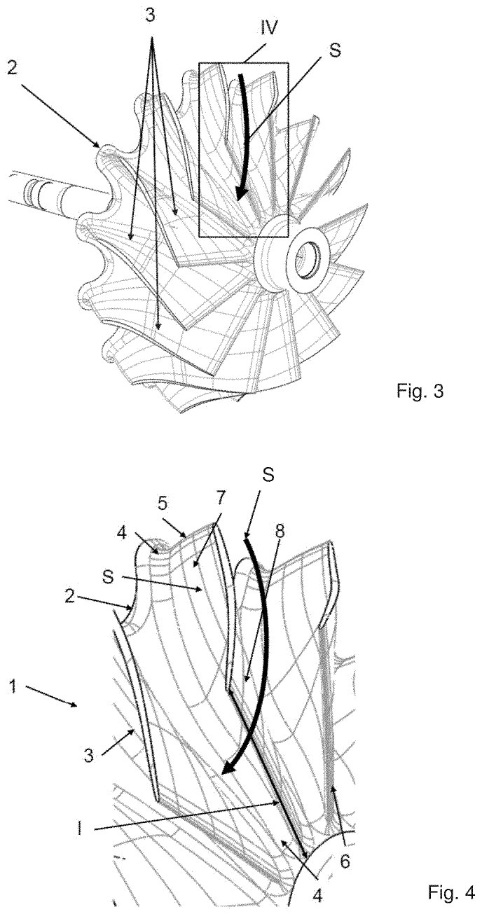

FIG. 3 shows a perspective view of a turbocharger turbine rotor 1 which is subjected to an inflow directed radially to the rotor axis. The turbocharger turbine rotor 1 of FIG. 3 also comprises a rotor basic body 2 and moving blades 3 that are integrally formed on the rotor basic body 2. FIG. 4 shows the detail IV of FIG. 3. The turbocharger turbine rotor of this design is referred to as turbocharger radial turbine rotor. The flow direction of the turbocharger radial turbine rotor is in turn visualized in FIG. 3, 4 by an arrow S.

The moving blades 3 of the respective turbocharger turbine rotor 1 merge into the rotor basic body 2 inside forming a defined curvature region 4, wherein this curvature region 4 is also referred to as fillet. On the outside, the moving blades 3 are formed without a shroud.

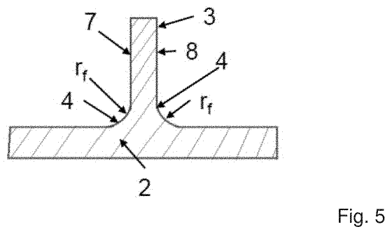

The curvature regions 4 of the moving blades, with which the moving blades 3 merge into the rotor basic body 2, are characterized by a curvature radius r_{f}. See FIG. 5. This curvature radius r_{f} can be a constant curvature radius r_{f} or a variable curvature radius r_{f}.

The moving blades 3 have a defined length l in the radial direction a flow trailing edge 6, wherein all moving blades 3 preferentially have the identical length l in the radial direction at the flow trailing edge 6.

The moving blades 3 form a first group of first moving blades and a second group of second moving blades 3. The first group of first moving blades comprises multiple moving blades 3 and the second group of second moving blades comprises at least one moving blade 3.

The following relationship (1):

0.025≤r_{f1}/l≤0.1 or 2.5%≤r_{f1}*100/l≤10% (1)
applies on the first group of first moving blades 3 for the curvature radius r_{f} of the curvature region 4 of the first moving blades 3, which is referred to as r_{f1}
wherein
r_{f1} is the constant or variable curvature radius of the curvature region of the first moving blades,
l is the length of the first moving blades at a flow trailing edge.

On the second group of second moving blades 3 the curvature radius r_{f} of the curvature region 4 of the second moving blades 3, which is referred to as r_{f2}, deviates from the curvature radius r_{f1} of the curvature region 4 of the first moving blades 3 on the damping side, namely in a damping-optimized manner in order to provide, subject to providing a targeted frequency detuning between the moving blades 3 of the turbocharger turbine rotor 1, optimum vibration damping characteristics of the turbocharger turbine rotor 1 so that the turbocharger turbine rotor 1 can be continuously operated in all operating points. The curvature radius r_{f2} of the curvature region 4 of the respective second moving blade 3 deviates from the curvature radius r_{f1} of the curvature region 4 of the first moving blades 3 such that the curvature radius r_{f2} of the curvature region 4 of the respective second moving blades 3 does not satisfy the above relationship (1) for the curvature radius r_{f1} of the curvature region 4 of the first moving blades 3.

The number of the second moving blades of the second group amounts to between 15% and 60% of the total number of first and second moving blades 3 of the first and second group.

Each moving blade 3 has a flow leading edge 5, the flow trailing edge 6, and flow-guiding sides or surfaces 7, 8 extending between the flow leading edge 5 and the flow trailing edge 6, wherein one of these flow-guiding surfaces is embodied as suction side and the other one of these flow-guiding surfaces as pressure side. The flow leading edge 5, the flow trailing edge 6 and these flow-guiding surfaces 7, 8 extend into the curvature region 4 of the respective moving blade 3.

In each position of the curvature region 4, i.e., in the region of the flow leading edge 5, in the region of the flow trailing edge 6 and in the regions of the flow-guiding surfaces 7, 8 extending between the flow leading edge 5 and the flow trailing edge 6, a curvature radius r_{f} is formed.

In a moving blade with constant curvature radius, the curvature radius in each position of the curvature region 4, i.e., in the region of the flow leading edge 5, in the region of the flow trailing edge 6 and in regions of the sides 7 and 8 extending between the flow leading edge and the flow trailing edge is identical in size. Then, a constant curvature radius extends in this case roundabout the entire curvature region 4. This type of curvature radius is referred to as constant curvature radius of the respective moving blade.

In a moving blade with variable curvature radius, the curvature radius in the region of a flow leading edge 5 and/or in the region of the flow trailing edge 6 and/or in regions of the sides 7 and 8 extending between the flow leading edge and the flow trailing edge differs in size. In this case, the curvature radius, emanating from the respective flow leading edge 5, varies in the direction of the respective flow trailing edge 6. This type of curvature radius is referred to as variable curvature radius of the respective moving blade.

Regardless of whether the first moving blades 3 of the first group have a constant or variable curvature radius in the respective curvature region 4, the relationship (1), i.e.:

0.025≤r_{f1}/l≤0.1 or 2.5%≤r_{f1}*100/l≤10%

applies to the curvature radius of the first moving blades 3 in each position of the curvature region.

In particular when the curvature radius r_{f1} on the first moving blades 3 in the curvature region 4 is constant, the following relationship (2):

r_{f2}=r_{f1}*1.2 to 3 or 1.2≤r_{f2}/r_{f1}≤3 or 120%≤r_{f2}*100/r_{f1}≤300% (2)

preferentially applies to the curvature radius r_{f2} of the curvature region 4 of the respective second moving blade 3.

In particular when the curvature radius r_{f1} on the first moving blades is constant, the curvature radius r_{f2} on the or each second moving blade is preferentially also constant.

In particular when the curvature radius r_{f1} on the first moving blades is variable, the following relationship (3):

r_{f2}=r_{f1}*1.3 to 4 or 1.3≤r_{f2}/r_{f1}≤4 or 130%≤r_{f2}*100/r_{f1}≤400% (3)

preferentially applies to the curvature radius r_{f2} of the curvature region 4 of the respective second moving blade 3.

In particular when the curvature radius r_{f1} on the first moving blades is variable, the curvature radius r_{f2} on the or each second moving blade is preferentially also variable.

With the invention present here a turbocharger turbine rotor for a turbocharger can be provided, which is embodied as an integrally bladed turbine rotor without outer shroud and has a resonance-proof blading, so that the turbine, namely the turbocharger turbine rotor, can be safely operated with optimal damping characteristics in all operating points.

A turbocharger according to the invention comprises a turbine for expanding a first medium and a compressor for compressing a second medium utilizing energy extracted in the turbine during expansion of the first medium. The turbine comprises a turbine housing and a turbine rotor subjected to a flow. The compressor comprises a compressor housing and a compressor rotor that is coupled to the turbine rotor via a shaft. The turbine housing and the compressor housing are each connected to a bearing housing arranged between the same, in which the shaft is mounted. The turbine rotor is configured according to the invention as described above. The turbine rotor can be an axial turbine rotor or a radial turbine rotor.

### LIST OF REFERENCE NUMBERS

1 Turbine rotor
2 Rotor basic body
3 Moving blade
4 Curvature region
5 Flow leading edge
6 Flow trailing edge
7 Surface
8 Surface

We claim:

1. A turbocharger turbine rotor (1), comprising:
a rotor basic body (2); and
a plurality of moving blades (3) integrally formed on the rotor basic body (2), wherein the plurality of moving blades (3) are configured without an outer shroud,
wherein the plurality of moving blades (3), forming a defined curvature region (4), merge into the rotor basic body (2) with a defined constant or variable curvature radius r_{f},
wherein on a first group of first moving blades of the plurality of moving blades (3) the following relationship applies to the curvature radius of the curvature region (4) of the first moving blades (3):
2.5%≤r_{f1}*100/l≤10%,
wherein r_{f1} is a constant or variable curvature radius of the curvature region of the first moving blades and l is a length of the first moving blades on a flow trailing edge (6), and
wherein on a second group of second moving blades of the plurality of moving blades (3) a curvature radius r_{f2} of the curvature region (4) of the second moving blades (3) deviates from the curvature radius r_{f1} of the curvature region (4) of the first moving blades (3) on the damping side.

2. The turbocharger turbine rotor according to claim 1, wherein the curvature radius r_{f2} of the curvature region (4) of the respective second moving blades (3) deviates from the curvature radius r_{f1} of the curvature region (4) of the first moving blades (3) such that the curvature radius r_{f2} of the curvature region (4) of the respective second moving blades (3) does not satisfy the relationship for the curvature radius r_{f1} of the curvature region (4) of the first moving blades (3).

3. The turbocharger turbine rotor according to claim 2, wherein on the respective second moving blades (3) the curvature radius r_{f2} of the curvature region (4) of the second moving blades (3) deviates from the curvature radius r_{f1} of the curvature region (4) of the first moving blades (3) in a damping-optimized manner.

4. The turbocharger turbine rotor according to claim 3, wherein in a case in which the curvature radius r_{f1} on the first moving blades is constant, the following applies to the curvature radius r_{f2} of the respective second moving blade (3):
120%≤r_{f2}*100/r_{f1}≤300%.

5. The turbocharger turbine rotor according to claim 4, wherein in a case in which the curvature radius r_{f1} on the first moving blades is constant, the curvature radius r_{f2} on the respective second moving blade is also constant.

6. The turbocharger turbine rotor according to claim 5, wherein with a moving blade having a constant curvature radius in each position of the curvature region (4), in the region of a flow leading edge (5), the curvature radius in the region of the flow trailing edge (6) and in regions of sides (7, 8) extending between the flow leading edge and the flow trailing edge, is equal in size.

7. The turbocharger turbine rotor according to claim 3, wherein in a case in which the curvature radius r_{f1} on the first moving blades is variable, the following applies to the curvature radius r_{f2} of the respective second moving blade (3):
130%≤r_{f2}*100/r_{f1}≤400%.

8. The turbocharger turbine rotor according to claim 7, wherein in particular in a case in which the curvature radius r_{f1} on the first moving blades is variable, the curvature radius r_{f2} on the respective second moving blade is also variable.

9. The turbocharger turbine rotor according to claim 8, wherein with a moving blade having a variable curvature radius in the region of a flow leading edge (5) and/or in the region of the flow trailing edge (6) and/or in regions of sides (7, 8) extending between the flow leading edge and the flow trailing edge, the curvature radius is different in size.

10. The turbocharger turbine rotor according claim 1, wherein the first group of first moving blades comprises multiple moving blades and the second group of second moving blades comprises at least one moving blade.

11. The turbocharger turbine rotor according to claim 1, wherein the percentage of the second moving blades in the total number of the moving blades is between 15% and 60%.

12. A turbocharger comprising:
a turbine configured to expand a first medium; and
a compressor configured to compress a second medium utilizing energy extracted in the turbine during the expansion of the first medium,
wherein the turbine comprises a turbine housing and the turbine rotor according to claim 1,
wherein the compressor comprises a compressor housing and a compressor rotor that is coupled to the turbine rotor via a shaft,
wherein the turbine housing and the compressor housing are each connected to a bearing housing arranged therebetween, in which the shaft is mounted.

13. The turbocharger according to claim 12, wherein the turbine rotor is an axial turbine rotor.

14. The turbocharger according to claim 12, wherein the turbine rotor is a radial turbine rotor.
